(19) United States
(12) Patent Application Publication
(10) Pub. No.: US 2014/0257877 A1
(43) Pub. Date: Sep. 11, 2014

(54) LOCATION SENSITIVE PROCESSING OF RESTAURANT ORDERS

(71) Applicants: Israel L'Heureux, Monaco (MC); Mark D. Alleman, Portland, OR (US)

(72) Inventors: Israel L'Heureux, Monaco (MC); Mark D. Alleman, Portland, OR (US)

(21) Appl. No.: 13/242,437

(22) Filed: Sep. 23, 2011

(51) Int. Cl. G06Q 50/00; G06Q 10/00

(52) U.S. Cl. 705/5; 705/15

(57) ABSTRACT

A restaurant portal server receives an order for a menu item on a menu of a restaurant from a computing device via a wide area network. The order is associated with a customer account identity. A geographic location of the computing device or a mobile communication device associated with the customer account identity is determined. A message is sent from the restaurant portal server to an order management system of the restaurant to add the order to an active queue of the order management system to be fulfilled by service personnel of the restaurant. Upon detecting that the geographic location of the customer, the computing device, or the mobile communication device is within a threshold proximity to a target geographic location of the restaurant, a message is provided to instruct service personnel to fulfill the order.

### BACKGROUND

In many restaurants, during busy periods, diners must wait an agonizingly long time from ordering their food to receiving their meals. Waiting can be frustrating to diners, particularly for people on a tight schedule, or for people with young children who cannot endure the wait. Long wait times are often not due to backups in the kitchen, but rather may be due to the process of waiting on customers, which is inherently inefficient. For example, much of a waiter's job is waiting—waiting for the customer to read through the menu, waiting as the customer asks other people at their table what they plan to eat, and waiting, while the customer reconfirms with the other people. During these periods, the waiter is unable to assist other customers, deliver food, seat new parties, check parties out, or buss tables, resulting in delays for everyone. Further delay may occur when diners have trouble comprehending the menu or deciding their order. These delays decrease the profitability of the restaurant, since faster turnover of customers often yields higher profit margins. Frustrated with these delays, some diners may not order additional beverages or desserts, and may even resort to placing to-go orders. However, this decreases the profitability of the restaurant and lowers the pleasure experienced by the diner.

### SUMMARY

Location sensitive processing of restaurant orders initiated at a computing device is disclosed. As one example, a restaurant portal server receives an order for a menu item on a menu of a restaurant from the computing device via a wide area network. The order is associated with a customer account identity at the restaurant portal server. A geographic location of the customer, the customer's computing device, or a mobile communication device associated with the customer account identity is determined from communications with the device or from a user input provided by the customer or service personnel when the customer arrives at the restaurant. A message is sent from the restaurant portal server to an order management system of the restaurant to add the order to an active queue of the order management system to be fulfilled by service personnel of the restaurant. Upon detecting that the geographic location of the customer, customer's computing device, or the mobile communication device associated with the customer account identity is within a threshold proximity to a target geographic location of the restaurant, a message is sent from the restaurant portal server, from the computing device, or from the mobile communication device to the order management system to instruct service personnel to fulfill the order. Claimed subject matter, however, is not limited by this summary as other implementations may be disclosed by the written description and associated drawings.

### BRIEF DESCRIPTION OF DRAWINGS

FIG. 1 is a schematic diagram depicting an example computing system for a restaurant or group of restaurants according to one embodiment.

FIG. 2 is a flow diagram depicting an example method for processing restaurant orders initiated at a computing device according to one embodiment.

FIG. 3 is a flow diagram depicting an example method for a computing device according to one embodiment.

FIG. 4 is a schematic diagram depicting further aspects of the example computing system of FIG. 1.

FIG. 5 is a communication diagram showing interactions between a user client, a restaurant server system, and a portal server, during various phases from set up to supporting both the restaurant and the user during an in-restaurant dining experience, according to one embodiment.

FIG. 6 is schematic view of a computing system according to another embodiment of the invention, which may be configured to implement at least the method of FIG. 5.

FIG. 7 shows a view of a restaurant service support graphical user interface of the computer system FIG. 6.

FIG. 8 shows a view of a customer support graphical user interface of the computer system FIG. 6.

FIG. 9 shows a view of a customer support graphical user interface of the computer system FIG. 6.

FIG. 10 is a flow diagram depicting another example method for processing restaurant orders initiated at a computing device according to one embodiment.

### DETAILED DESCRIPTION

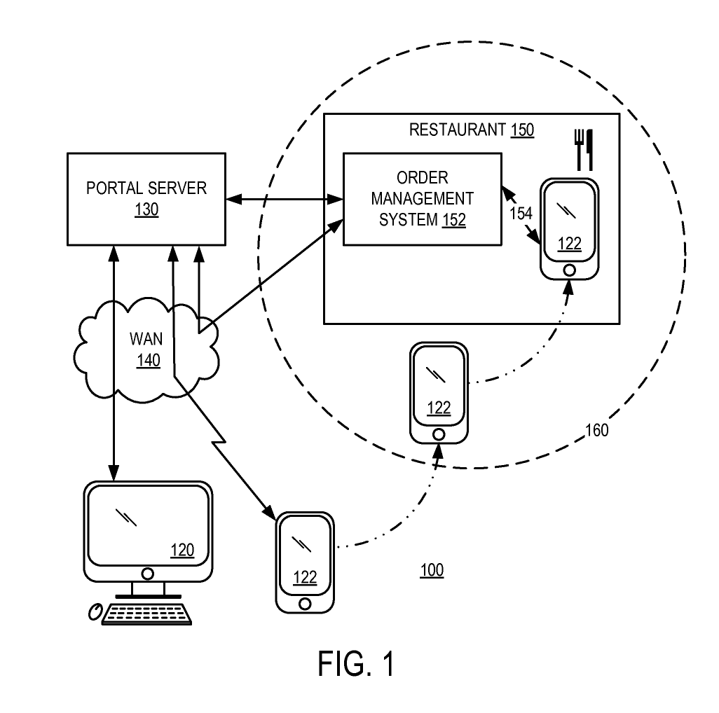

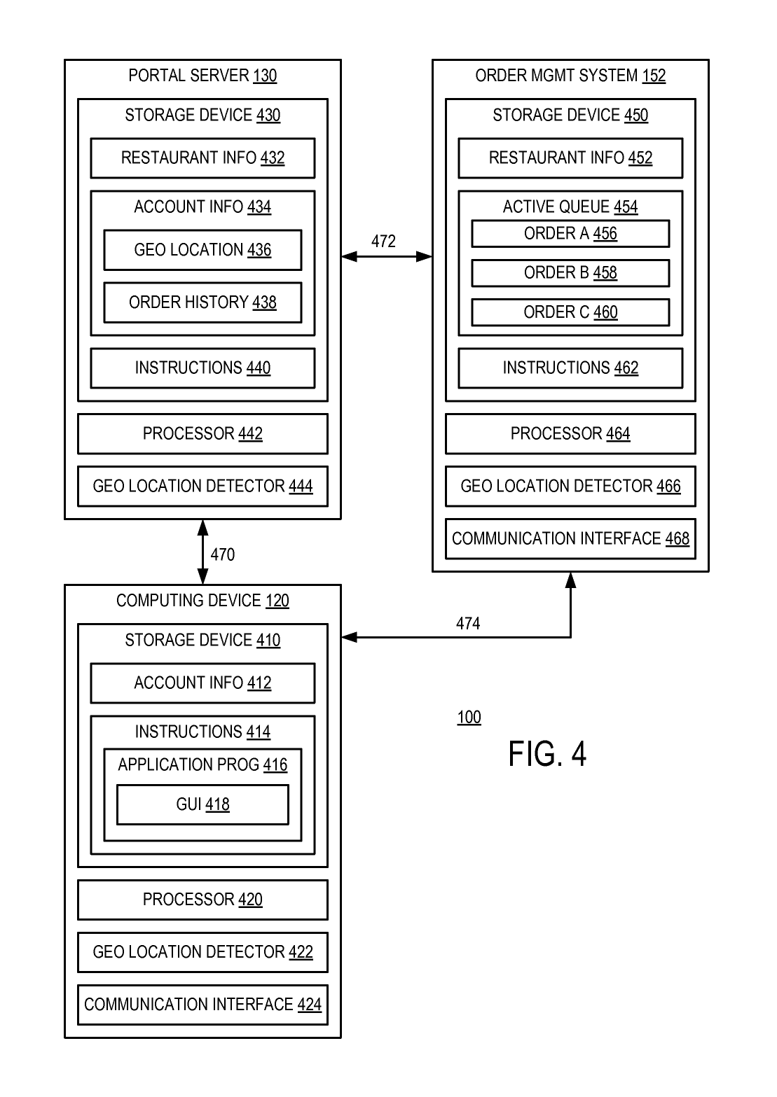

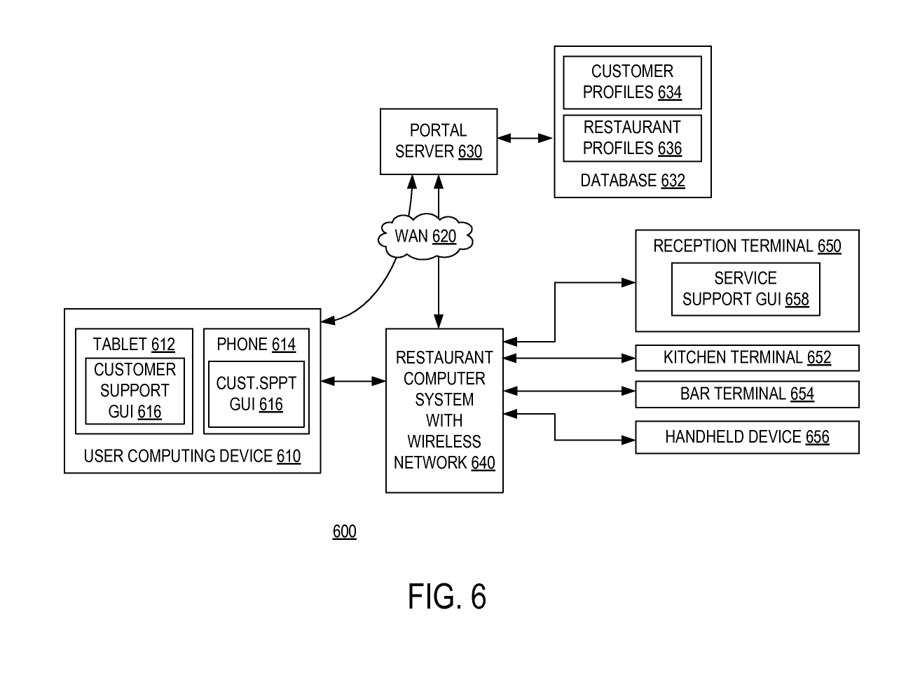

FIG. 1 is a schematic diagram depicting an example computing system 100 for a restaurant or group of restaurants according to one embodiment. Computing system 100 may include an online restaurant portal server 130 that facilitates communication between consumers and the restaurant. Portal server 130 may be configured to receive an order for a menu item on a menu of a restaurant 150 from a computing device 120 via a wide area network (WAN) 140 (e.g., the Internet, a cellular communications network, or combination thereof). Portal server 130 may be configured to send a message to an order management system 152 of restaurant 150 to add the order to an active queue of the order management system to be fulfilled by service personnel of the restaurant. Order management system 152 may take the form of a restaurant computing system that includes a restaurant server system and/or one or more restaurant computing devices (e.g., terminals) as will be described in greater detail with respect to FIGS. 4 and 6.

Portal server 130 may be configured to associate the order with a customer account identity for a user (e.g., customer) that placed the order for the menu item and with a restaurant account identity to which the order is to be directed. The customer account identity may include or may be associated with customer profile information in a database at the portal server or accessible to the portal server. Similarly, the restaurant account identity may include or may be associated with restaurant profile information in the database at the portal server or accessible to the portal server. For example, an order may be associated with the customer account identity by the portal server adding order information for the menu item to the customer profile information, and may be associated with the restaurant account identity indicated by the order by the portal server adding the order information to the restaurant profile information.

A customer account identity for a user may span multiple user devices, such as computing device 120 and mobile communication device 122. Hence, a user may place an order for a menu item of a restaurant via computing device 120, but may travel to the restaurant carrying mobile communication device 122. Mobile communication device 122 may be a mobile computing device (e.g., a cell phone, smart phone, GPS enabled device, etc.) or a wireless electronic tag such as an RFID tag. In some scenarios, computing device 120 may itself be a mobile communication device.

A restaurant account identity for a restaurant may be associated with a group of restaurants that is represented by a restaurant group identity. For example, a corporate restaurant chain may be represented by a restaurant group account identity and each restaurant of the restaurant group may be associated with a distinguishable restaurant account identity. Restaurant profile information may be specific to an individual restaurant or to multiple restaurants of a restaurant group.

Portal server 130 may be configured to detect a geographic location of computing device 120 and/or mobile communication device 122 associated with the customer account identity. Portal server 130 may be configured to send a message to order management system 152 to instruct service personnel to fulfill the order upon detection that the geographic location of computing device 120 or mobile communication device 122 associated with the customer account identity is within a threshold proximity 160 to a target geographic location of restaurant 150.

Alternatively, order management system 152 may be configured to detect a geographic location of computing device 120 and/or mobile communication device 122. Order management system 152 may be configured to present a message instructing service personnel to fulfill the order upon detection that the geographic location of computing device 120 or mobile communication device 122 is within threshold proximity 160 to the target geographic location of restaurant 150.

Alternatively, computing device 120 or mobile communication device 122 may be configured to detect that a geographic location of the computing device or mobile communication device is within threshold proximity 160 to a target geographic location of restaurant 150. Computing device 120 or mobile communication device 122 may be configured to, upon detection that the geographic location of the computing device or mobile communication device is within the threshold proximity, send a message to restaurant portal server 130 to initiate delivery of the order to order management system 152 of restaurant 150 and/or a message instructing service personnel to fulfill the order, or may send a message to order management system 152 (e.g., via wireless link 154) to instruct service personnel to fulfill the order previously received from restaurant portal server 130.

Detection of a geographic location of a mobile communication device may be performed by (1) the mobile communication device reporting its location to the portal server, where the portal server compares the reported location to the restaurant location, or (2) the mobile communication device may be informed of the location of restaurant from the portal server, and the mobile communication device reports to the portal server if or when the mobile communication device is within a threshold proximity of the restaurant location. The proximity of the mobile communication device from the location of the restaurant may be expressed as a distance of the mobile communication device from the location of the restaurant or as an estimated time of travel (e.g., by driving, walking, public transportation, etc.) for the user of the mobile communication device to the location of the restaurant.

In each of these scenarios, detection of a computing device or mobile communication device within a threshold proximity of a target geographic location may be used to initiate preparing or fulfilling an order previously submitted by a user via the computing device. However, in other implementations, the presence of a customer at the restaurant may be detected by a user input received via a user interface of the restaurant order management system by the customer or by service personnel acknowledging the presence of the customer at the restaurant. In response to detecting the customer's presence at the restaurant via the user input, the order previously received via the portal server may be fulfilled by the service personnel.

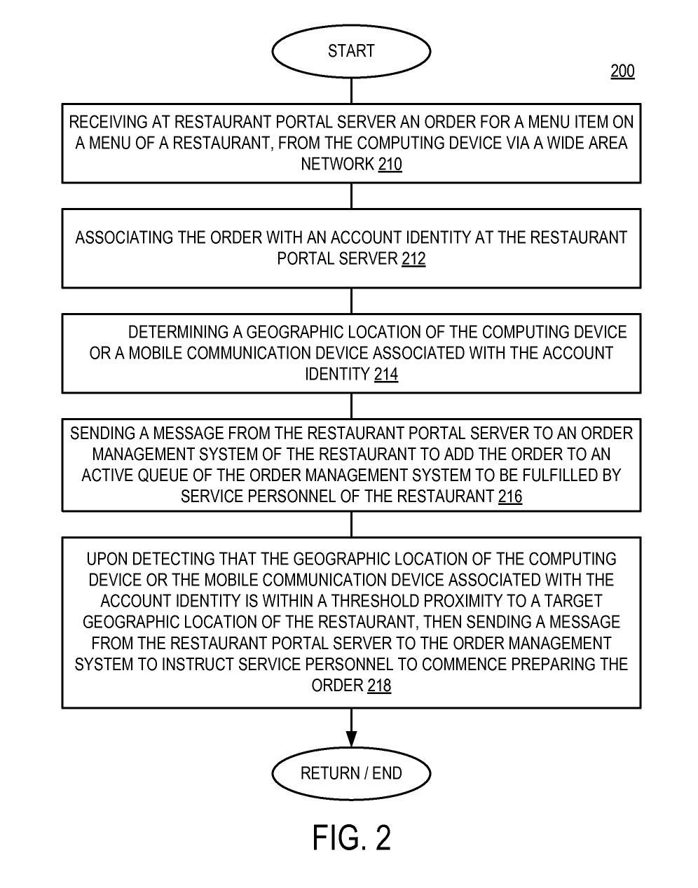

FIG. 2 is a flow diagram depicting an example method 200 for processing restaurant orders initiated at a computing device according to one embodiment. For example, method 200 may be performed, at least in part, by previously described restaurant portal server 130.

At 210, method 200 includes receiving an order for a menu item on a menu of a restaurant from the computing device at a restaurant portal server via a wide area network. The order received from the computing device may additionally indicate an identity of the restaurant, for example, if the restaurant portal server supports ordering for a number of restaurants. Prior to 210, method 200 may include sending menu information to the computing device via the wide area network for presentation of a menu interface at the computing device.

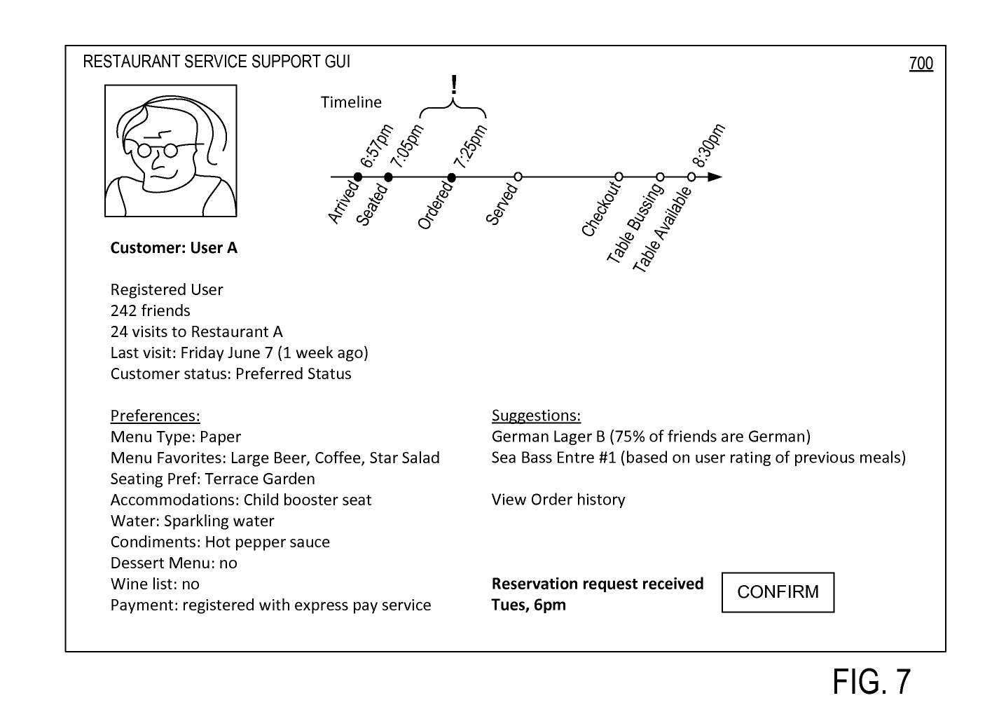

The menu information sent to the computing device may be customized based, at least in part, on customer profile information associated with the customer account identity, the geographic location of the restaurant, and/or the geographic location of the computing device or the mobile communication device associated with the customer account identity. A history of orders associated with the customer account identity may be maintained, and menu items most frequently present in the history of orders and/or menu items tagged as a favorite menu item by a user associated with the customer account identity may be sent to the computing device for presentation to the user. Popular menu items, as measured by order popularity or by user feedback received from a user population over time by the portal server, may also be indicated as such graphically, or otherwise, to the user. Information regarding relative degree of popularity may also be included. Example graphical user interfaces are described with reference to FIGS. 7, 8, and 9.

The order may be received via the menu interface presented at the computing device. Method 200 may further include providing an online checkout interface to the computing device or the mobile communication device associated with the customer account identity. The online checkout interface may enable a user to pay for the order via the computing device or the mobile communication device.

At 212, method 200 includes associating the order with a customer account identity at the restaurant portal server. The restaurant portal server may maintain a database of orders attributed to the customer account identity stored in association with an identifier of the customer account identity. The database may also include billing or payment information associated with the customer account identity, such as bank account or credit card information.

At 214, method 200 includes determining a geographic location of the computing device or a mobile communication device associated with the customer account identity. The geographic location of the computing device or of the mobile communication device may be detected in a number of ways. For example, the computing device or mobile communication device may be a GPS enabled device that reports its geographic location to the restaurant portal server, the order management system of the restaurant, or other suitable intermediate service. As another example, the computing device may utilize near-field wireless communications such as Bluetooth or Wi-Fi that may be detected by the order management system of the restaurant to detect that the computing device or mobile communication device is within threshold proximity of a wireless access point of the restaurant. As yet another example, wireless communications of the computing device or mobile communication device with one or more wireless access points (e.g., wireless 3G or 4G base stations) may be triangulated or otherwise measured to detect the geographic location of the computing device or mobile communication device.

At 216, method 200 includes sending a message from the restaurant portal server to an order management system of the restaurant to add the order to an active queue of the order management system to be fulfilled by service personnel of the restaurant. The active queue may be associated with a point-of-sale system residing at the restaurant to present the order to the service personnel. Customer profile update information may be sent to a server device associated with a social networking environment via the WAN responsive to the geographic location of the computing device or the mobile communication device associated with the customer account identity being within the threshold proximity to the target geographic location. A customer profile may be updated at the social network environment responsive to the update information to indicate that the user associated with the customer profile has “checked-in” to the target geographic location. The customer profile may be accessible by one or more other users within the social networking environment.

At 218, method 200 includes, upon detecting that the geographic location of the computing device or the mobile communication device associated with the customer account identity is within a threshold proximity to a target geographic location of the restaurant, then sending a message from the restaurant portal server to the order management system to instruct service personnel to fulfill the order. For example, an indication may be presented via a graphical display of the order management system for the service personnel to fulfill the order. The order management system may take the form of a point of sale (POS) system, for example.

At 218, method 200 may further include outputting an indication including customer profile information of the customer account identity to the service personnel responsive to the geographic location of the computing device or the mobile communication device associated with the customer account identity being within the threshold proximity to the target geographic location. A history of orders associated with the customer account identity may be sent to a computing device associated with the restaurant (e.g., the order management system or other suitable computing device) for presentation of the history to the service personnel.

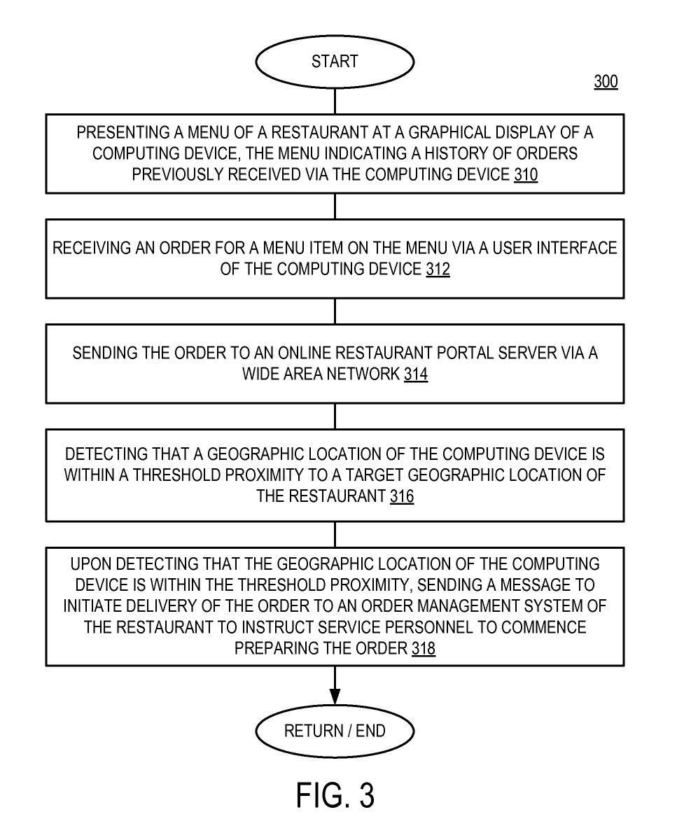

FIG. 3 is a flow diagram depicting an example method 300 for a computing device according to one embodiment. For example, method 300 may be performed, at least in part, by a computing device such as previously described computing device 120 and/or mobile communication device 122 associated with a common customer account identity.

At 310, method 300 includes presenting a menu of a restaurant at a graphical display of a computing device. The menu may include a number of menu items, and may indicate a history of orders previously received via the computing device. The history of orders may provide the user with information useful for ordering one or more other menu items in a subsequent order. The history of orders may be stored locally at the computing device, or may be received from a remote server device such as previously described restaurant portal server.

At 312, method 300 includes receiving an order for a menu item on the menu via the user interface (e.g., a keyboard, touch-sensitive graphical display, pointer device, etc.) of the computing device. For example, a user may select one or more menu items via the user interface. An online checkout interface may be presented via the graphical display to enable a user to pay for the order via the computing device.

At 314, method 300 includes sending the order to the restaurant portal server via a wide area network. The restaurant portal server receives and processes the order, for example, as previously described with reference to method 200 of FIG. 2. At 316, method 300 includes detecting that a geographic location of the computing device is within a threshold proximity to a target geographic location of the restaurant. The computing device may detect geographic location in a number of ways. For example, the computing device may be a GPS enabled device. As another example, the computing device may utilize near-field wireless communications such as Bluetooth or Wi-Fi to detect that the computing device is within threshold proximity of a wireless access point associated with the target geographic location. As yet another example, the computing device may triangulate or otherwise determine the geographic location from wireless signals received from one or more wireless access points, such as one or more wireless 3G or 4G base stations. However, as previously discussed, another computing device such as the restaurant portal server or the order management system located at the restaurant may detect the geographic location of the computing device.

At 318, method 300 includes, upon detecting that the geographic location of the computing device is within the threshold proximity, sending a message to the order management system of the restaurant or to the restaurant portal server to instruct service personnel to fulfill the order. In some implementations, the message sent to the restaurant portal server may further initiate delivery of the order to the order management system of the restaurant that was previously sent to the portal server.

FIG. 4 is a schematic diagram depicting further aspects of the example computing system 100 of FIG. 1, including computing device 120, restaurant portal server 130, and order management system 152. Computing device 120 may communicate with order management system 152 over a wired and/or wireless communications link 474. Computing device 120 may communicate with restaurant portal server 130 via a wired and/or wireless communications link 470. Restaurant portal server 130 may communicate with order management system 152 over a wired and/or wireless communications link 472.

While further aspects of computing device 120 are depicted in FIG. 4, mobile communication device 122 may include the same or similar components as those described with reference to computing device 120. Computing device 120 may include a computer readable storage device 410 having information stored thereon, including account information 412 and instructions 414. Instructions 414 may include an application program 416. Application program 416 may include a graphical user interface 418. Graphical user interface 418 may enable a user to order menu items of a menu of a restaurant and/or pay for an order. Computing device 120 may include a processor 420 that may execute instructions 414 to perform one or more of the methods or operations described herein. Computing device 120 may include a geographic location detector 422 to detect a geographic location of computing device 120. Geographic location detector 422 may include a GPS receiver or wireless communications receiver, and associated electronics for identifying or estimating a geographic location of the computing device. Communication interface 424 may include a wired and/or wireless receiver and/or transmitter for facilitating communications with portal server 130 and/or order management system 152.

Portal server 130 may include a computer readable storage device 430 having information stored thereon, including restaurant information 432, account information 434, and instructions 440. Account information 434 may include geographic location information for computing device 120 and/or order history information 438 for a customer account identity. Portal server 130 may include a processor 442 that may execute instructions 440 to perform one or more of the methods or operations described herein. Portal server 130 may include a geographic location detector 444 to detect a geographic location of computing device 120 or mobile communication device 122. Geographic location detector 444 may, for example, receive geographic longitude and latitude coordinates for computing device 120 (or mobile communication device 122), and may compare those coordinates to coordinates of a target geographic location of a restaurant, for example. Geographic location detector 444 may include any suitable hardware and/or software (e.g., instructions executable by processor 464) to enable portal server 130 to detect the geographic location of the computing device or mobile communication device.

Order management system 152 may include a computer readable storage device 450 having information stored thereon, including restaurant information 452, active queue information 454, and instructions 462. Restaurant information 452 may include menus from which menu items may be ordered by users. Active queue information 454 is depicted with example orders 456, 458, 460, etc. Active queue information 454 may be presented via a graphical display of order management system 152 for service personnel. Order management system 152 may include a processor 464 that may execute instructions 462 to perform one or more of the methods or operations described herein. Order management system 152 may include a geographic location detector 466 to detect a geographic location of computing device 120 or mobile communication device 122. For example, geographic location detector 466 may identify computing devices and/or mobile communication devices in wireless communication with an access point of the order management system, and may detect devices that are associated with a customer account identity that has submitted an order to the restaurant. Geographic location detector 466 may include any suitable hardware and/or software (e.g., instructions executable by processor 464) to enable order management system 152 to detect the geographic location of the computing device or mobile communication device. Communication interface 468 may include a wired and/or wireless receiver and/or transmitter (e.g., an access point) for communicating with computing device 120 and/or mobile communication device 122.

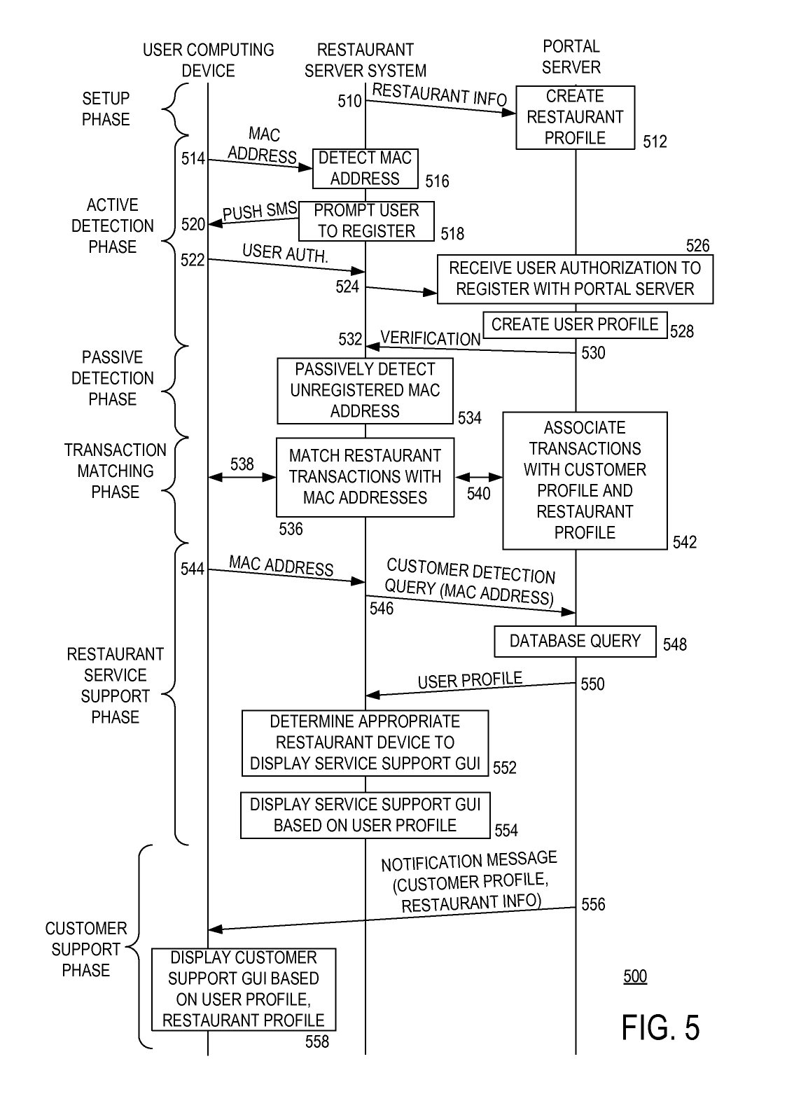

FIG. 5 is a communication diagram showing an example method 500 for use in restaurants including interactions between a user computing device, a restaurant server system, and a portal server, during various phases from set up to supporting both the restaurant and the user during an in-restaurant dining experience, according to one embodiment.

A setup phase of method 500 may include operations 510 and 512. At 510, the method may include, at a restaurant server system, sending restaurant information to a portal server. At 512, the method may include, at the portal server, creating a restaurant profile based on the restaurant information sent by the restaurant server system.

An active detection phase of method 500 may include operations 514-528. At 514, the method may include, at a user computing device, sending a user computing device identifier (ID) (e.g., a Bluetooth or Wi-Fi MAC address) to a restaurant server system via a wireless local area network. At 516, the method may include, actively detecting the user computing device ID in wireless signals from the user computing device by the order management system of a restaurant. At 518, the method may include prompting a user of the user computing device to register with the restaurant portal server. As one example, a user of the user computing device may be prompted by sending or pushing an SMS message (e.g., text message) or other suitable message at 520 to the user computing device via the wireless local area network. In some implementations, the SMS or other suitable message sent to the user computing device at 520 may provide a notification to the user even if a software application for interacting with the restaurant is closed.

At 522, the user computing device may send a user authorization to the restaurant server system. At 524, the method may include receiving the user authorization at the restaurant server system and forwarding the user authorization to the restaurant portal server. At 526, the method may include, at the portal server, receiving the user authorization to register with the portal server. At 528, the method may include creating a customer profile at the portal server. At 530, the method may include, at the portal server, sending verification to the restaurant server system that a customer profile was successfully created for the user. At 532, the method may include receiving, at the restaurant server system, the verification from the restaurant portal server that a customer profile was successfully created for the user.

A passive detection phase of method 500 may include operations 534. At 534, the method may include passively detecting unregistered user computing device IDs in wireless signals from user computing devices, at the order management system of the restaurant. The computing device ID may include a Bluetooth or Wi-Fi MAC address of the user computing device, for example.

A transaction matching phase of method 500 may include operations 536-542. At 536, the method may include, at the restaurant server system, matching point of sale restaurant transactions (e.g., sale receipts) with the detected unregistered user computing device IDs. The matching performed at 536 may include communications 538 between user computing devices and the restaurant server system. At 540, the restaurant server system may send transaction information to the portal server. At 542, the method may include, at the portal server, associating transactions of each unregistered user computing device with aggregated transaction data stored in a restaurant profile at the portal server. In this way, a customer's purchasing activity may be passively tracked, restaurant transactions may be matched or otherwise attributed to individual customers, and the matched restaurant transactions may be reported to the portal server where it may be aggregated over a number of customers to provide feedback to customers and service personnel in the form of which items are popular among customers of the restaurant, even among unregistered customers.

A restaurant service support phase of method 500 may include operations 544-554. At 550, the method may include retrieving customer profile information associated with detected user computing device IDs at the restaurant server system from a data storage device. The data storage device may reside locally at restaurant and form part of the restaurant server system and/or the data storage device may reside remotely at the portal server accessible to the restaurant server system via a wide area network. For example, the portal server may provide customer profile information to the restaurant server system responsive to requests made by the restaurant server system. At 552, the method may include determining, at the restaurant server system, an appropriate display device of order management system of the restaurant on which to display the restaurant service support graphical user interface, from among a plurality of display devices located at different locations in the restaurant. At 554, the method may include displaying a restaurant service support GUI on a restaurant computing device of the order management system. The restaurant service support GUI may display the retrieved customer profile information. The retrieved customer profile information may include one or more of: customer dining preferences, menu suggestions, an order history, and/or a dining experience timeline, for example. Customer dining preferences may include one or more of: a menu type, a seating type, menu favorites, special accommodations such as handicap or child seat, a type of water or beverage, condiment preferences, likes or dislikes dessert, likes or dislikes the wine list, payment preferences, etc. In some implementations, a corporate restaurant chain may develop a proprietary database for customer dining preferences or other profile information that spans multiple restaurants of the restaurant chain.

A user support phase of method 500 may include operations 556 and 558. At 556, the method may include, upon receiving a request from the user computing device, transmitting from the restaurant portal server to the user computing device, customer profile information associated with the user computing device ID and restaurant profile information for the restaurant. At 558, the method may include displaying a user support graphical user interface on the user computing device based on the received customer profile information and restaurant profile information. As one example, the user support graphical user interface may display one or more of: (a) popular items as determined by transaction data aggregated from the order management system of the restaurant; (b) suggestions by the restaurant chef, critics, or a population of diners; (c) a restaurant menu with menu items selectable by a customer, the selection of which causes an order for the selected menu item to be sent via the restaurant portal server to the order management system of the restaurant, along with the user device client ID sufficient to locate the table at which the customer is sitting at in the restaurant; (d) a customer order history at the restaurant; and/or (e) the customer's current order and payment status.

FIG. 6 is schematic view of a computing system 600 according to another embodiment of the invention, which may be configured to implement the method of FIG. 5, for example. Computing system 600 includes a user computing device 610. User computing device 610 may include, for example, a tablet computing device 612 that displays a customer support GUI 616. As another example, user computing device 610 may include a phone 614 that displays the customer support GUI 616.

Computing system 600 may include an on-premises restaurant computer system 640 that provides a wireless local area network to the restaurant. Restaurant computer system 640 may communicate with user computing device 610 via the wireless local area network. Computing system 600 may further include one or more on-premises restaurant computing devices and/or graphical display devices such as a reception terminal 650, a kitchen terminal 652, a bar terminal 654, and a handheld device 656. A service support GUI 658 may be displayed via one or more of reception terminal 650, kitchen terminal 652, bar terminal 654, and handheld device 656, etc.

Computing system 600 may include a portal server 630 that include or has access to a database 632. Database 632 may include customer profile information 634 and restaurant profile information 636. User computing device 610 and restaurant computer system 640 may communicate with portal server 630 via WAN 620. Database 632 may be held in a data storage device of portal server 630 or in a data storage device accessible to portal server 630. Restaurant computer system 640 may include a local copy of database 632 or a portion thereof held in a data storage device of the restaurant computer system, for example. In some implementations, portal server 630 may be omitted or may be incorporated into restaurant computer system 640 to enable a restaurant to obtain the functionality described herein without necessarily requiring the network access of a wide area network.

FIG. 7 shows a view of an example restaurant service support GUI 700 of computer system 600 of FIG. 6. GUI 700 includes a customer photograph, customer profile information (e.g., customer name, age, or other biographical information), user preferences, user suggestions, and historical information. Historical information may include an indication of customer activity at the restaurant or business, and may take the form of a timeline, graphical indicator, textual or numerical information, or other suitable indicator. In FIG. 7, the following types of historical information are displayed from the user profile: number of social network friends, number of visits to this restaurant, date and time of last visit, customer status level (new, occasional, preferred, regular, etc.). A full order history may be viewed via an order history link. The GUI 700 may also display user preferences, suggestions for menu items, as well as reservation information for current, prior, and/or future reservations. The preferences may include a preferred menu type, a preferred seating type, menu favorites, special accommodations such as handicap or child seat, a preferred type of water or beverage, condiment preferences, dessert preferences, wine preferences, and payment preferences, etc. Suggestions may be displayed for menu items that the system determines the user might enjoy based on the user's historical information and user preferences, and possibly based on other user feedback received for the suggested menu items. Some user preferences and/or historical information may be provided across multiple restaurants whereas other user preferences and/or historical information may be provided for particular restaurants. GUI 700 further indicates that a reservation request was received from the user associated with the customer profile information. GUI 700 includes a selector to enable service personnel of the restaurant to confirm or deny the reservation.

In some implementations, restaurant service support GUI 700 may be presented via a display device of the restaurant in response to detection of the customer at the restaurant or responsive to a request by service personnel to display the customer profile information. Restaurant service support GUI 700 enables service personnel to recognize customers and/or obtain information relating to customers of the restaurant or business. For example, even new service personnel may use the information presented via restaurant service support GUI 700 to identify whether a customer is a regular customer or high spending customer even if the new service personnel has never met that customer. Service personnel are enabled by the information displayed by restaurant service support GUI 700 to provide a personalized greeting to the customer, such as: “Hello Mr. Johnson, glad to see you again” or “would you care for your favorite table, drink, or food item this evening?”.

Restaurant service support GUI 700 may be configured to display an alert when a customer detected in the restaurant has experienced a delay of more than a predetermined time period during a corresponding service phase. For example, restaurant service support GUI 700 may display a graphical alert icon (e.g., “!” or other suitable indicator) if the time elapsed during an ordering phase has exceeded a threshold time period. Each phase of service may have a different threshold, e.g., set by a restaurant administrator, and statistics may be generated by the restaurant order management system and/or portal server to report how timely the service staff are serving customers. Example service phases may include an ordering phase, a food preparation phase, a beverage refill phase, an appetizer ordering and/or delivery phase, an entre ordering and/or delivery phase, a dessert ordering and/or delivery phase, etc.

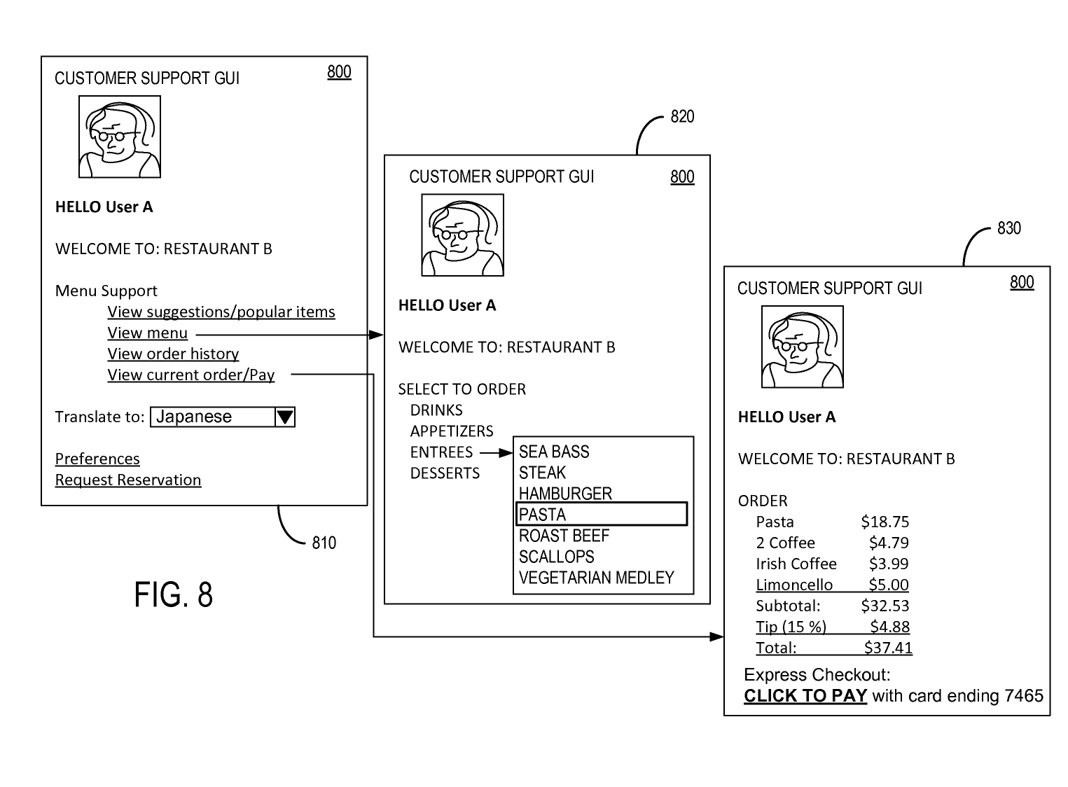

FIG. 8 shows a sequence of views 810, 820, and 830 of a customer support graphical user interface 800 of computer system 600 of FIG. 6. At view 810, a user selects “view menu” to be presented with menu items that may be ordered from the restaurant as indicated by view 820. At view 810, a user selects “view current order/pay” to be presented with a summary of the current order and a selector to initiate payment as indicated by view 830. GUI 800 may enable a user to invoke an “express pay” option, whereby the user's credit card information is maintained at one or more of the user's computing device, at the restaurant server system, or at the portal server to facilitate payment of the order. GUI 800 includes in view 810, a selector to translate the GUI to a different language, such as Japanese, for example. View 810 further includes a selector to enable the user to see user preferences, and a selector to enable the user to request a reservation from the restaurant.

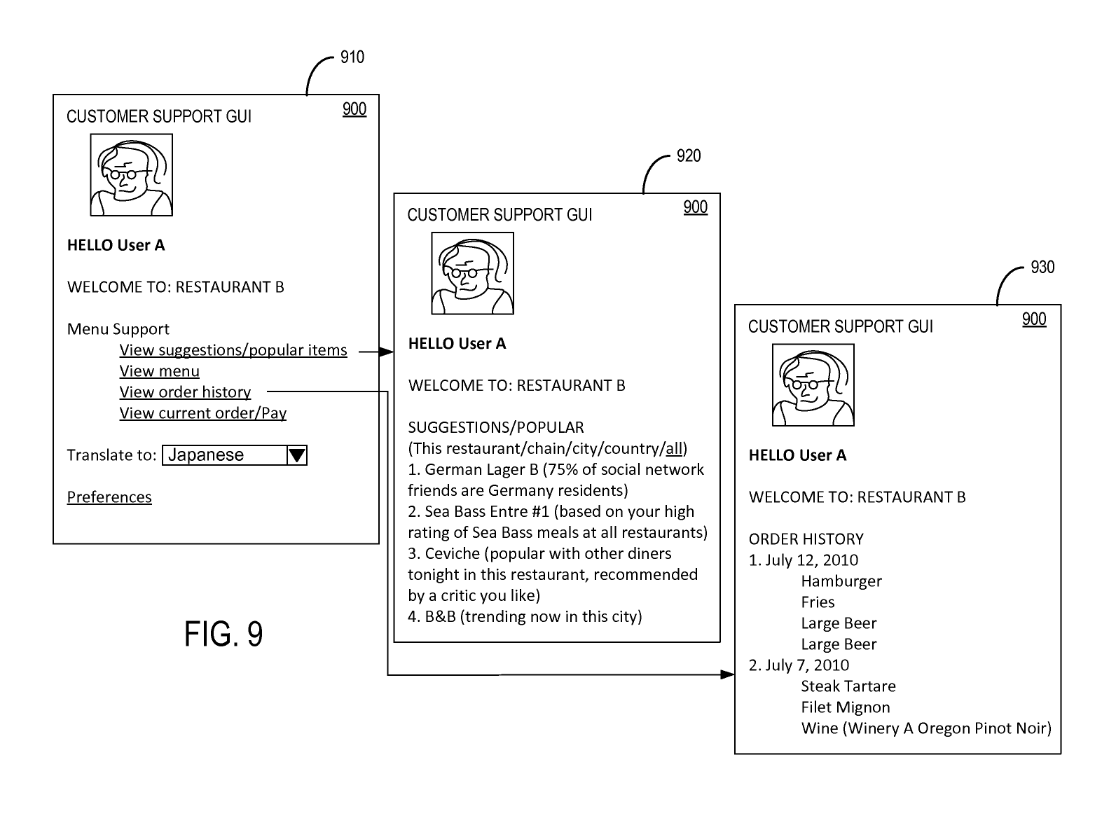

FIG. 9 shows a sequence of views 910, 920, and 930 of a customer support graphical user interface 900 of computer system 600 of FIG. 6. At view 910, a user selects “view suggestions/popular items” to be presented with menu items that are popular and/or suggested for the user as indicated by view 920. As previously discussed, these suggestions may be based on the user's past activity and/or the restaurant with which the user is placing the order. The suggestions and/or popular items of view 920 may include a selector to enable a user to order one or more of the suggested or popular items. At view 910, the user selects “view order history” to be presented with an order history that spans days, weeks, months, years, or other suitable time as indicated by view 930. The order history of view 930 may include a selector to enable a user to re-order one or more of the menu items previously ordered by the user. The popular items, order history, and suggestions may be provided to users based on passive monitoring of customer activity at a restaurant. Such passive monitoring may replace or augment restaurant review content that has been actively provided by customers.

In some implementations, two or more customers of a restaurant may be grouped for purposes of providing common ordering, paying, and/or billing. For example, two or more customers seated at the same table of the restaurant may desire to pay or order via a common transaction initiated by a particular customer of the group on behalf of the other customers of the group. Customers may be grouped via their respective user computing devices. For example, a customer support GUI, such as previously described GUIs 800 and 900, may prompt a customer to provide the identity of other customers with which the customer is to be grouped. The restaurant order management system and/or portal server may group customers based on the customer's response to the prompt. As another example, customers may be grouped by the customer's syncing their respective user computing devices or bumping (i.e., electronically or physically coupling) their respective computing devices to establish a group. A group of customers may pay and/or order via a common transaction. For example, a first customer may pay for products or services ordered by another customer of the group.

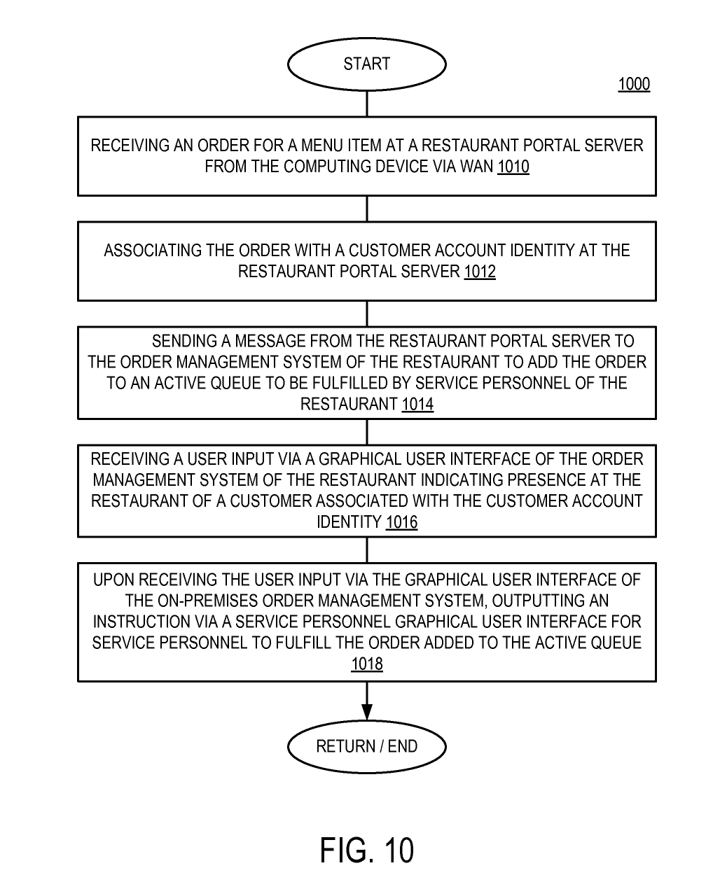

FIG. 10 is a flow diagram depicting another example method 1000 for processing restaurant orders initiated at a computing device according to one embodiment. At 1010, the method may include receiving an order for a menu item on a menu of a restaurant at a restaurant portal server from the computing device via a wide area network. The order received from the computing device may indicate an identity of the restaurant (e.g., a restaurant account identity) to enable the portal server to direct the message to the order management system of the restaurant. The method may further include sending menu information to the computing device via the wide area network for presentation of a menu interface at the computing device. Receiving the order from the computing device at 1010 may include receiving the order via the menu interface presented at the computing device. The method may further include customizing the menu information sent to the computing device based, at least in part, on one or more of: customer profile information associated with the customer account identity, a geographic location of the restaurant, a geographic location of the computing device, and/or a geographic location of a mobile communication device associated with the customer account identity.

At 1012, the method may include associating the order with a customer account identity at a restaurant portal server, for example, as previously discussed. At 1014, the method may include sending a message from the restaurant portal server to the order management system of the restaurant to add the order to an active queue to be fulfilled by service personnel of the restaurant.

At 1016, the method may include receiving a user input via a graphical user interface of the order management system of the restaurant indicating presence at the restaurant of a customer associated with the customer account identity. In some examples, the user input may be received from the customer upon arriving at the restaurant. In other examples, the user input may be received from service personnel of the restaurant upon the customer checking in at reception or with a waiter upon being seated at a table. The method may further include, upon receiving the user input via the user interface of the order management system, outputting an indication including customer profile information associated with the customer account identity via the service personnel user interface. The method may further include, upon receiving the user input via the user interface of the order management system, sending updated customer profile information to a server device associated with a social networking environment to indicate the customer's presence at the restaurant. This feature may be referred to as a “check-in” notification within the social networking environment.

At 1018, the method may include, upon receiving the user input via the graphical user interface of the order management system, outputting an instruction via a service personnel graphical user interface for service personnel to fulfill the order added to the active queue.

In some implementations, the method may further include maintaining a history of orders associated with the customer account identity, and sending to the computing device for presentation, an indication of menu items most frequently present in the history of orders and/or an indication of menu items tagged as a favorite menu item by the customer associated with the customer account identity. The method may further include receiving a reservation request initiated from the computing device, and sending a reservation response to the computing device indicating acceptance or denial of the reservation request responsive to an input received from the service personnel of the restaurant via the service personnel user interface. The method may further include providing an online checkout interface to the computing device or a mobile communication device associated with the customer account identity, the online checkout interface enabling the customer to pay for the order via the computing device or the mobile communication device.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims. Numerous examples have been described in the context of processing orders for a restaurant. However, the disclosed systems and methods may be utilized in other contexts beyond restaurants, including any suitable business establishment, for example.

1. A method for processing restaurant orders initiated at a computing device, comprising:
receiving an order for a menu item on a menu of a restaurant at a restaurant portal server from the computing device via a wide area network;
associating the order with a customer account identity at the restaurant portal server;
sending a message from the restaurant portal server to an order management system of the restaurant to add the order to an active queue to be fulfilled by service personnel of the restaurant;
receiving a user input via a graphical user interface of the order management system of the restaurant indicating presence at the restaurant of a customer associated with the customer account identity; and
upon receiving the user input via the graphical user interface of the order management system, outputting an instruction via a service personnel user interface for service personnel to fulfill the order added to the active queue; and
upon receiving the user input via the graphical user interface of the order management system, sending updated customer profile information to a server device associated with a social networking environment to indicate the customer's presence at the restaurant.

2. The method of claim 1, further comprising:
maintaining a history of orders associated with the customer account identity; and
sending to the computing device for presentation, an indication of menu items most frequently present in the history of orders and/or an indication of menu items tagged as a favorite menu item by the customer associated with the customer account identity.

3. The method of claim 1, wherein the order received from the computing device indicates an identity of the restaurant to enable the portal server to direct the message to the order management system of the restaurant;
the method further comprising:
receiving a reservation request initiated from the computing device; and
sending a reservation response to the computing device indicating acceptance or denial of the reservation request responsive to an input received from the service personnel of the restaurant via the service personnel user interface.

4. The method of claim 1, further comprising:
sending menu information to the computing device via the wide area network for presentation of a menu interface at the computing device, wherein receiving the order from the computing device includes receiving the order via the menu interface presented at the computing device; and
customizing the menu information sent to the computing device based, at least in part, on one or more of: a customer profile information associated with the customer account identity, a geographic location of the restaurant, a geographic location of the computing device, and/or a geographic location of a mobile communication device associated with the customer account identity.

5. The method of claim 1, further comprising:
providing an online checkout interface to the computing device or a mobile communication device associated with the customer account identity, the online checkout interface enabling the customer to pay for the order via the computing device or the mobile communication device.

6. The method of claim 1, further comprising:
upon receiving the user input via the graphical user interface of the order management system, outputting an indication including customer profile information associated with the customer account identity via the service personnel user interface.

7. (canceled)

8. A computing system for a restaurant or group of restaurants, comprising:
a restaurant portal server configured to:
receive an order for a menu item on a menu of a restaurant from a computing device via a wide area network;
associate the order with a customer account identity;
maintain an order history associated with the customer account identity;
determine a geographic location of the computing device or a mobile communication device associated with the customer account identity by detecting a MAC address of the computing device or a mobile communication device associated with the customer account identity via a wireless local area network of the restaurant;
send a message to an order management system of the restaurant to add the order to an active queue of the order management system to be fulfilled by service personnel of the restaurant; and
upon detection that the geographic location of the computing device or the mobile communication device associated with the customer account identity is within a threshold proximity to a target geographic location of the restaurant, send a message to the order management system to instruct service personnel to fulfill the order added to the active queue and output an indication of customer profile information including the order history associated with the customer account identity to the order management system for presentation to the service personnel of the restaurant.

9. The system of claim 8, the restaurant portal server further configured to:
send menu items most frequently present in the order history and/or menu items tagged as a favorite menu item by a user associated with the customer account identity to the computing device for presentation.

10. The system of claim 8, wherein the order received from the computing device indicates an identity of the restaurant; and
wherein the active queue is associated with a point-of-sale system of the order management system residing at the restaurant to present the order to the service personnel.

11. The system of claim 8, the restaurant portal server further configured to:
send menu information to the computing device via the wide area network for presentation of a menu interface at the computing device, wherein the order is received from the computing device via the menu interface presented at the computing device; and
customize the menu information sent to the computing device based, at least in part, on one or more of: the customer profile information associated with the customer account identity, a geographic location of the restaurant, a geographic location of the computing device, and/or a geographic location of the mobile communication device associated with the customer account identity.

12. The system of claim 8, the restaurant portal server further configured to:
provide an online checkout interface to the computing device or the mobile communication device associated with the customer account identity, the online checkout interface enabling a customer to pay for the order via the computing device or the mobile communication device.

13. (canceled)

14-20. (canceled)
